(19) United States
(12) Patent Application Publication
(10) Pub. No.: US 2015/0375118 A1
(43) Pub. Date: Dec. 31, 2015

(54) Spin for A Kiss

(71) Applicants: David Agaronov, Brooklyn, NY (US); Farrukh Khamroev, Brooklyn, NY (US)

(72) Inventors: David Agaronov, Brooklyn, NY (US); Farrukh Khamroev, Brooklyn, NY (US)

(21) Appl. No.: 14/850,188

(22) Filed: Sep. 10, 2015

(51) Int. Cl. A63F 13/57; A63F 13/63; A63F 13/87; A63F 13/35

(52) U.S. Cl. CPC A63F 13/57; A63F 13/35; A63F 13/63; A63F 13/87

(57) ABSTRACT

The various embodiments herein disclose a computer readable gaming application comprising the steps of choosing an avatar or a self-image to create a player profile. The player logs into the gaming application through the created profile. The logging is achieved through a mobile or a computing device. The player selects a private or public table for playing the game and performs a swiping action to rotate an animated bottle over an animated table through a touch-sensitive sensitive screen of the mobile device. The method further comprises selecting an action to be performed by a user opted after rotating the animated bottle and selecting a live chat option to communicate with at-least one user in the game.

### BACKGROUND

1. Technical Field of Invention

The embodiments herein generally relate to a multi-user gaming application with features to award or send or receive gifts.

2. Description of Related Art

A multi-player gaming application is mobile or computing device friendly software application with feasibility to involve multiple players at a time. The players can play the game in real time being in-sight or out-of-sight as the present gaming concept facilitates as the players involvement through LAN.

Many gaming applications now-a-days are mobile compatible and have multi-player involvement. The number of players are added dynamically during a run of play. Most of multi-player games are played over PCs and laptops as such games require high memory and processing speed.

Although many conventional gaming applications allows a multi-player participation but fails to provide a simultaneous medium of continuous communication like audio or video. The prior gaming applications are also limited over facilitation of a selection to create a public or private game table over a mobile device.

Spin the Bottle is a party game in which several players sit/stand/kneel in a circle. A bottle is placed on the floor in the centre of the circle. A player spins the bottle, and must kiss the person to whom the bottle points when it stops spinning It is popular among teenagers and is very embarrassing to most. Though there have been many online games coming up wherein multiple users can play simultaneously but there is still a need to come up with an online game wherein the users can have the fun to play the game “spin the bottle” online through their mobile devices or computers.

The above mentioned shortcomings, disadvantages and problems are addressed herein, as detailed below.

### SUMMARY OF THE INVENTION

Thus, the primary object of the embodiments herein is to provide a mobile as well as a computer based multi-player gaming application for playing the “spin the bottle” game online.

Another object of the embodiments herein is to provide a mobile as well as computer based multi-player gaming application with multiple real as well as non-real time player interaction modes.

Yet another object of the embodiments herein is to provide an online spin the bottle game wherein the user can play with his known and unknown friends or users by selecting a specific group or an unknown group.

The embodiments herein provide a computer readable gaming application. The computer readable gaming application comprises downloading and installing a gaming application over a mobile device or a computing device. An avatar or a self-image is chosen to create a user profile over the installed gaming application. The gaming application is logged into through the created user profile. The logging-in is achieved through the mobile or the computing device. A plurality of users are invited to join the gaming application. The list of the users who have accepted the invitation is displayed on a profile page of the user. The user who has accepted the invitation is referred to as a “player”. A private table or a public table is selected for playing a game in the gaming application. A request is sent to one or more players to join a game. The game involves spinning an animated bottle over a selected animated table displayed on a screen of the mobile device or the computing device. The players who have accepted the request are displayed over the screen around the animated table. A swiping action is performed to spin the animated bottle over the animated table through a touch-sensitive screen of the mobile device or the computing device. The spun bottle stops after a predetermined time and points one of the players. An action is selected to be performed by the player being pointed.

The selected action comprises virtual or physical kissing a player who has spun the bottle. The physical kissing is done when the players are sitting in a room and spinning the bottle using the mobile or the computer device. The virtual kissing is done when the players are playing from distant places. The virtual kissing is achieved by selecting a kiss option on a display of the mobile device or the computing device.

The selected action further comprises sending an animated heart as a monetary trade to the user. The hearts are accumulated in the user's profile account. The users with highest number of hearts are highlighted over the gaming application.

The selected action further comprises purchasing and sending a gift, selecting an animated bottle for the game and selecting an animated drinking bottle.

The predetermined time for stopping a bottle is 2 seconds to 20 seconds.

The logging is achieved via a social networking website or directly through an email registration created solely for the gaming application.

A live chat option is selected to communicate with at-least one user in the game. The live chat is provided on a part of the mobile or the computing device.

The live chat comprises a public chat and a private chat. The public chat is performed among all the players joining the table and the private chat is performed between at-least two players or users. The chat content in the private chat is viewed only by the allowed players or users.

The game is played through a single mobile device by the player present at same location.

The game is played through a plurality of mobile device present at different locations, wherein the players from different location are connected through an internet connectivity.

The game is further played through an offline mode during an absence of an internet connectivity over at-least one player's mobile device, wherein a position of each player over the created table is fixed, wherein a player spins the animated bottle over the table, wherein an action from the spinning of the bottle and stopping over another player is recorded, wherein the action is transmitted to other players as soon as the internet connectivity is gained again over the mobile device.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates a flowchart for the process followed in gaming application, according to an embodiment herein.

FIG. 2 illustrates a window for sending gifts through the gaming application, according to an embodiment herein.

FIG. 3 illustrates a window for chatting with other players during a game, according to an embodiment herein.

### DETAILED DESCRIPTION OF THE DRAWINGS

In the following detailed description, a reference is made to the accompanying drawings that form a part hereof, and in which the specific embodiments that may be practiced is shown by way of illustration. The embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The embodiments herein provide an online gaming application for multiple users. The embodiments herein provide a system and method for playing an online game by multiple users wherein the game is similar to the “spin the bottle” game. The “spin the bottle” game is played online using a mobile or a computer device according to the present invention.

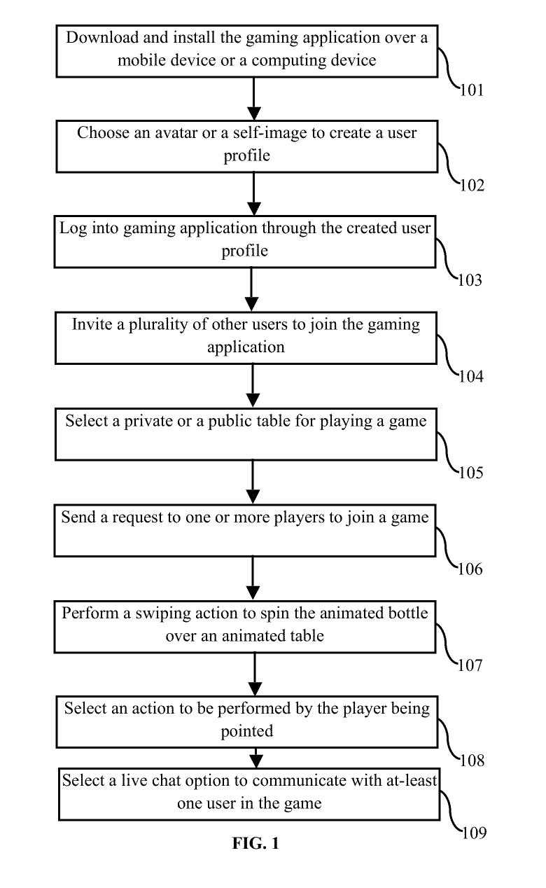

FIG. 1 illustrates a flowchart showing the various steps involved in the process followed in a gaming application, according to an embodiment herein. With respect to FIG. 1, the computer readable gaming application comprises downloading and installing the gaming application over a mobile device or a computing device by user (101). The user chooses an avatar or a self-image to create a user profile over the installed gaming application (102). The user logs into gaming application through the created user profile over the mobile device or the computing device (103). Further, the user invites a plurality of other users to join the gaming application (104). A list of the other users who have accepted the invitation is displayed on a profile page of the user. The users who have accepted the invitation are referred to as a “player”. The user further selects a private or a public table for playing a game in the gaming application (105). The user sends a request to one or more players to join a game (106). The players who have accepted the request are displayed over a side of a screen of the mobile device of the user. The game involves spinning an animated bottle over the selected animated table. The game is played by spinning the animated bottle over an animated table achieved through a swiping action performed on a touch-sensitive screen of the mobile device (107). The spun bottle stops after a predetermined time and points one of the players. The players then select an action to be performed by the player being pointed (108).

According to one embodiment herein, the players are also facilitated to select a live chat option to communicate with at-least one player during the game (109). The live chat is provided on a part of screen or display of the mobile or the computing device.

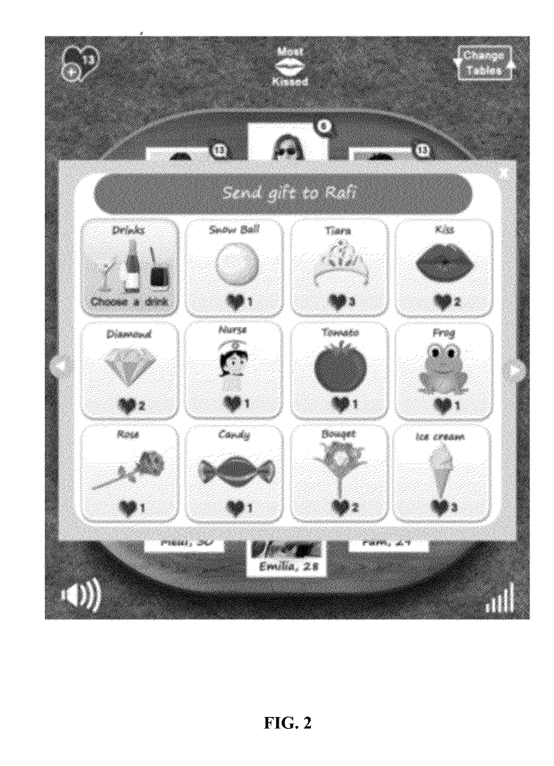

FIG. 2 illustrates a window for sending gifts through the gaming application, according to an embodiment herein. With respect to FIG. 2, the gift received over a user profile is accumulated in the user's profile account. The gifts received can also be encashed by the user as per his or her preference, according to another embodiment herein.

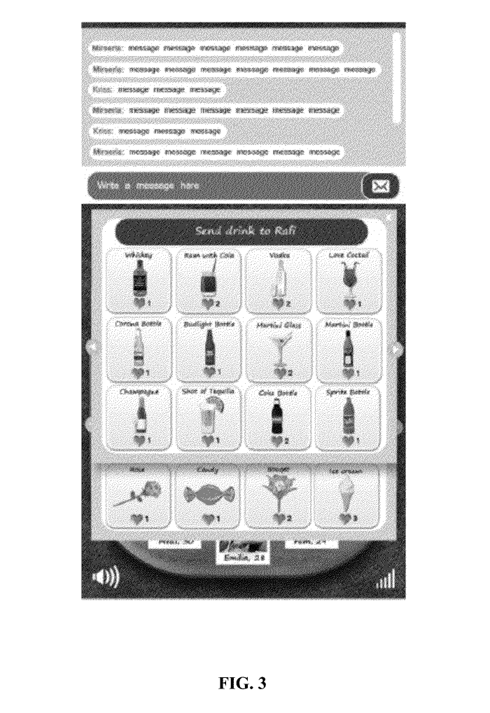

FIG. 3 illustrates a window for chatting with other players during a game, according to an embodiment herein. With respect to FIG. 3, the chat box is shown on a portion of display screen or over complete display screen of the mobile device or computing device.

According to one embodiment herein, the predetermined time for stopping a bottle is 2 seconds to 20 seconds.

According to one embodiment herein, the logging is achieved via a social networking website or directly through an email registration created solely for the gaming application.

According to one embodiment herein, the selected action comprises virtually or physically kissing a player who has spun the bottle. The physical kissing is done when the players are sitting in a room and spinning the bottle using a mobile or a computer device. The virtual kissing is done wherein the players are present at distant places. The virtually kissing is achieved by selecting a kiss option on a display of the mobile device or the computing device. The player also virtually sends the animated heart as a monetary trade to the user. The hearts are accumulated in the user's profile account. The users with highest number of hearts are highlighted over the gaming application.

According to one embodiment herein, the selected action further comprises purchasing and sending a gift, selecting an animated bottle for the game and selecting an animated drinking bottle.

According to one embodiment herein, the live chat comprises a public chat and a private chat. The public chat is performed among all the players joining the table. The private chat is performed between at-least two players or users. The chat content in the private chat is viewed only by the allowed players or users.

According to one embodiment herein, the game is played through a single mobile device by the player present at same location.

According to one embodiment herein, the game is played through a plurality of mobile device present at different locations. The players from different location are connected through an internet connectivity.

According to one embodiment herein, the game is further played through an offline mode during an absence of an internet connectivity over at-least one player's mobile device. A position of each player over the created table is fixed in an offline mode. A player spins the animated bottle and an action from the spinning of the bottle and stopping over another player is recorded. The action is transmitted to other players as soon as the internet connectivity is gained again over the mobile device.

According to an exemplary embodiment herein, the player also has options to sign up for the game through a registered email account or a Facebook™ account. The signing up comprises a plurality of player details further comprising a username, a profile picture, an age, a gender and a location. After successfully creating the login, the player has ability to browse and change the profile picture through a personal mobile device or a computing device. The gaming application further allows the player to adding friends or other players through the player's Facebook™ account or a social networking website account or a social networking mobile application account. The player starts the game by choosing a random table or creating a table with the selected friends or joining a previously owned or created table. The player has ability to join previously created table, if he or she has played earlier on the same table. After selecting a table, the player enters a game room that allows upto ten players from any part of the world to play on the same table. Each player gets a chance to spin the bottle that is placed in the centre of the screen. The bottle finally stops spinning and lands on a player. The player over whom the bottle has landed, chooses to kiss another player. If another player rejects the player (over whom the bottle has landed) to be “kissed”, a following player gets the next chance at spinning the bottle, and the process is repeated.

Throughout the game, all the players have ability to interact with each other on the second half of the screen, similar to a group chat. The game also allows a player to start a private chat with another player.

In order to be fully engaged in the game, the player has the option of buying “hearts”, sending gifts, and changing the bottle on the table, using the hearts as a monetary trade.

The gaming application is played primarily in a form of a competition where the players try to gain most kisses.

The gaming application further acts as a gateway to communicate with known as well as unknown users or persons across the globe in a better entertaining manner.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims.

I claim:

1. A computer readable gaming application comprises:
downloading and installing a gaming application over a mobile device or a computing device;
choosing an avatar or a self-image to create a user profile over the installed gaming application;
logging into gaming application through the created user profile, wherein the logging-in is achieved through the mobile or the computing device;
inviting a plurality of users to join the gaming application, wherein a list of the users who have accepted the invitation is displayed on a profile page of the user, wherein the person who has accepted the invitation are referred to as a “player”;
selecting a private or a public table for playing a game in the gaming application;
sending a request to one or more players to join a game, wherein the game involves spinning an animated bottle over a selected animated table displayed on a screen of the mobile device or the computing device, wherein the players who have accepted the request are displayed over the screen around the animated table;
performing a swiping action to spin the animated bottle over the animated table through a touch-sensitive screen of the mobile device or the computing device, wherein the spun bottle stops after a predetermined time and points one of the player;
selecting an action to be performed by the player being pointed.

2. The gaming application according to claim 1, wherein the selected action comprises virtual or physical kissing a player who have spun the bottle, wherein the physical kissing is done when the players are sitting in a room and spinning the bottle using the mobile or the computer device, and wherein the virtual kissing is done when the players are playing from distant places, wherein the virtual kissing is achieved by selecting a kiss option on a display of the mobile device or the computing device.

3. The gaming application according to claim 1, wherein the selected action comprises sending an animated heart as a monetary trade to the user, wherein the hearts are accumulated in the user's profile account, wherein the users with highest number of hearts are highlighted over the gaming application.

4. The gaming application according to claim 1, wherein the selected action comprises purchasing and sending a gift, selecting an animated bottle for the game and selecting an animated drinking bottle.

5. The gaming application according to claim 1, wherein the predetermined time for stopping a bottle is 2 seconds to 20 seconds.

6. The gaming application according to claim 1, wherein the logging is achieved via a social networking website or directly through an email registration created solely for the gaming application.

7. The gaming application according to claim 1, wherein a live chat option is selected to communicate with at-least one user in the game, wherein the live chat is provided on a part of the mobile or the computing device.

8. The gaming application according to claim 1, wherein the live chat comprises a public chat and a private chat, wherein the public chat is performed among all the players joining the table, wherein the private chat is performed between at-least two players or users, wherein the chat content in the private chat is viewed only by the allowed players or users.

9. The gaming application according to claim 1, wherein the game is played through a single mobile device by the player present at same location.

10. The gaming application according to claim 1, wherein the game is played through a plurality of mobile device present at different locations, wherein the player from different location are connected through an internet connectivity.

11. The gaming application according to claim 1, wherein the game is further played through an offline mode during an absence of an internet connectivity over at-least one player's mobile device, wherein a position of each player over the created table is fixed, wherein a player spins the animated bottle over the table, wherein an action from the spinning of the bottle and stopping over another player is recorded, wherein the action is transmitted to other players as soon as the internet connectivity is gained again over the mobile device.
